(19) United States
(12) Patent Application Publication
(10) Pub. No.: US 2024/0022689 A1
(43) Pub. Date: Jan. 18, 2024

(54) GENERATING A SOUND REPRESENTATION OF A VIRTUAL ENVIRONMENT FROM MULTIPLE SOUND SOURCES

(71) Applicant: TRUE MEETING INC., Los Altos, CA (US)

(72) Inventors: Ran OZ, Maccabim (IL); Nery STRASMAN, Los Altos, CA (US); Doron CASPI, Los Altos, CA (US)

(73) Assignee: TRUE MEETING INC., Los Altos, CA (US)

(21) Appl. No.: 18/354,608

(22) Filed: Jul. 18, 2023

Related U.S. Application Data
(63) Continuation-in-part of application No. 17/539,036, filed on Nov. 30, 2021.
Application No. 17/539,036 is a continuation of application No. 17/249,468, filed on Mar. 2, 2021, now Pat. No. 11,792,367.
Application No. 17/249,468 is a continuation-in-part of application No. 17/304,378, filed on Jun. 20, 2021, now Pat. No. 11,805,157.
Application No. 17/304,378 is a continuation of application No. 17/249,468, filed on Mar. 2, 2021, now Pat. No. 11,792,367.
(60) Provisional application No. 63/201,713, filed on May 10, 2021.
(60) Provisional application No. 63/199,014, filed on Dec. 1, 2020.
(60) Provisional application No. 63/081,860, filed on Sep. 22, 2020.
(60) Provisional application No. 63/023,836, filed on May 12, 2020.
(60) Provisional application No. 63/201,713, filed on May 10, 2021.

(51) Int. Cl. H04N 7/15; G06T 15/04; G06T 15/20; G06T 7/11; G06T 7/70; G06T 17/20; G06T 19/20; G06N 3/04; H04N 7/14; G06F 3/01; G06N 3/045

(52) U.S. Cl. CPC H04N 7/157; G06T 15/04; G06T 15/205; G06T 7/11; G06T 7/70; G06T 17/20; G06T 19/20; G06N 3/04; H04N 7/147; H04N 7/152; G06T 15/20; G06F 3/013; H04N 7/144; G06N 3/045; G06T 2200/08; G06T 2207/30201; G06T 2219/2004; G06T 19/00

(57) ABSTRACT

A method that includes (a) receiving sound information, at a computerized system of a given participant out of multiple groups of participants of a virtual three dimensional (3D) conference call, wherein the given participant belongs to a given group of the multiple groups of participants, wherein the sound information comprises (i) given group sound information that comprises sound sources related to participants of the given group that are allocated on a sub-group basis, (ii) other group sound information regarding sound that comprises sound sources related to participants of one or more groups that differ from the given group that are allocated on a group basis; and (b) generating by the computerized system, a sound representation of the virtual 3D conference call, based on the sound information.

### CROSS REFERENCE

This application is a continuation in part of U.S. patent application Ser. No. 17/249,468 filing date Mar. 2, 2021, which claims priority from U.S. provisional patent Ser. No. 63/023,836 filing date May 12, 2020, from U.S. provisional patent Ser. No. 63/081,860 filing date Sep. 22, 2020, and from U.S. provisional patent Ser. No. 63/199,014 filing date Dec. 1, 2020, all being incorporated herein in their entirety.

This application is a continuation in part of U.S. patent application Ser. No. 17/304,378 filing date Jun. 20, 2021, and from U.S. patent application Ser. No. 17/539,036 filing date Nov. 30, 2021, all being incorporated herein in their entirety.

### BACKGROUND

Video conference calls are very popular. They require that each participant has their own computerized system with a camera.

When a client-side device reconstructs a virtual environment, it is important to reduce the processing requirements because stand-alone devices tend to have limited resources for this activity. Sound reconstruction in a 3D environment may require many resources—especially if there are many sound sources. This can occur, for example, if the environment which is reconstructed is a large meeting space. For example, a virtual gathering may include some tens of participants. Each one of the real-world participants would want to have a good 3D virtual experience that would include decent rendering of all the sound sources in the gathering. Reconstructing a virtual 3D soundtrack comprised of tens of sources is unfeasible in the client-side.

There is a growing need to provide an effective method for generating sounds related to a virtual environments.

### SUMMARY

There may be provided a system, method and computer readable medium for Generating a sound representation of a virtual environment from multiple sound sources.

### BRIEF DESCRIPTION OF THE DRAWINGS

FIG. 1 illustrates an example of a method;

FIG. 2 illustrates an example of a computerized environment;

FIG. 3 illustrates an example of a computerized environment;

FIG. 4 illustrates an example of data structures;

FIG. 5 illustrates an example of a process for amending a direction of view of a 3D model of a part of a participant according to a direction of gaze of the participant;

FIG. 6 includes examples of methods;

FIG. 7 is an example of a panoramic view of a virtual 3D environment populated by five participants, a partial view of the some of the participants within the virtual 3D environment, and a hybrid view;

FIG. 8 illustrates two camera, fields of views of the two cameras, avatars and a displayed virtual 3D video conference environment (V3DVCE);

FIG. 9 illustrates two camera, fields of views of the two cameras, avatars and a displayed V3DVCE;

FIG. 10 illustrates two camera, fields of views of the two cameras, avatars and a displayed V3DVCE;

FIG. 11 illustrates two camera, fields of views of the two cameras, avatars and a displayed V3DVCE;

FIG. 12 illustrates a participant and an avatar;

FIG. 13 illustrates points of gaze of a participant and an avatar;

FIG. 14 illustrates an example of a method;

FIG. 15 illustrates an example of clustering of the sound sources into four groups;

FIG. 16 shows an example of sound information of a participant of a second sub-group;

FIG. 17 illustrates an example of a method; and

FIG. 18 illustrates an example of a method.

### DESCRIPTION OF THE DRAWINGS

In the following detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a system capable of executing the method and should be applied mutatis mutandis to a computer readable medium that is non-transitory and stores instructions for executing the method.

Any reference in the specification to a system should be applied mutatis mutandis to a method that may be executed by the system and should be applied mutatis mutandis to a computer readable medium that is non-transitory and stores instructions executable by the system.

Any reference in the specification to a computer readable medium that is non-transitory should be applied mutatis mutandis to a method that may be applied when executing instructions stored in the computer readable medium and should be applied mutatis mutandis to a system configured to execute the instructions stored in the computer readable medium.

The term “and/or” means additionally or alternatively.

Any reference to a “user” should be applied mutatis mutandis to the term “participant”—and vice versa.

There is provided a method, a non-transitory computer readable medium and a system related to video and may, for example be applicable to 3D video conference calls. At least some of the examples and/or embodiments illustrated in the applications may be applied mutatis mutandis for other purposes and/or during other applications.

The system may include multiple user devices and/or intermediate devices such as servers, cloud computers, and the like.

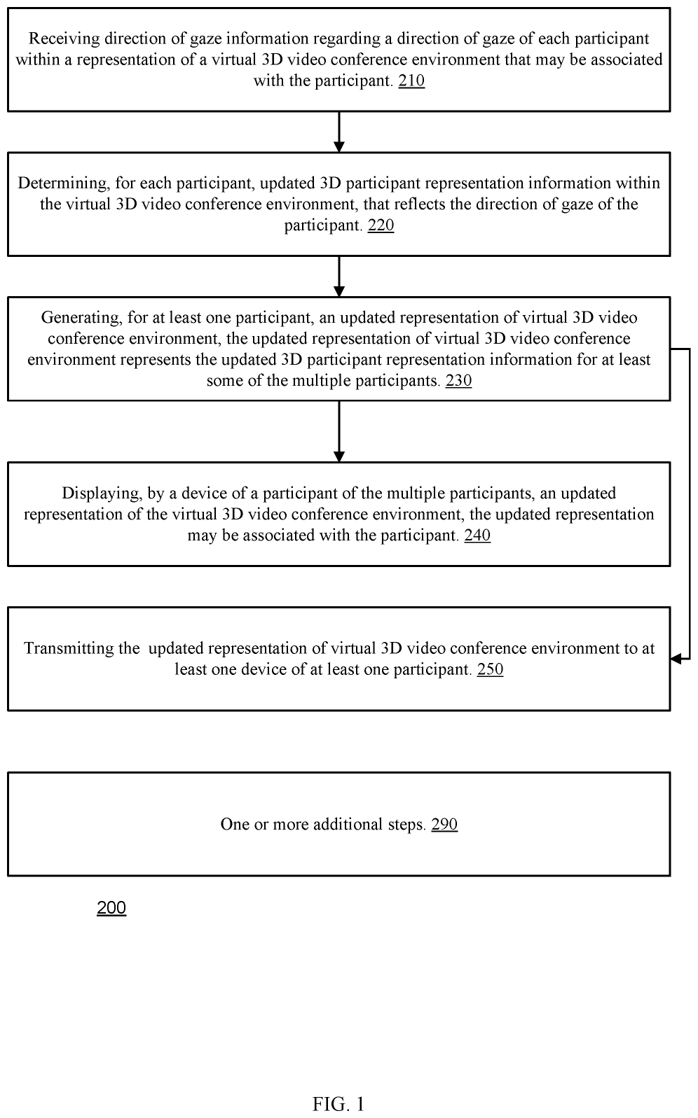

FIG. 1 illustrates an example of method 200.

Method 200 is for conducting a three-dimensional video conference between multiple participants.

Method 200 may include steps 210, 220 and 230.

Step 210 may include receiving direction of gaze information regarding a direction of gaze of each participant within a representation of a virtual 3D video conference environment that is associated with the participant.

The representation of a virtual 3D video conference environment that is associated with the participant is a representation that is shown to the participant. Different participants may be associated with different representation of a virtual 3D video conference environment.

The direction of gaze information may represent a detected direction of gaze of the participant.

The direction of gaze information may represent an estimated direction of gaze of the participant.

Step 220 may include determining, for each participant, updated 3D participant representation information within the virtual 3D video conference environment, which reflects the direction of gaze of the participant. Step 220 may include estimating how the virtual 3D video conference environment will be seen from the direction of gaze of the participant.

Step 230 may include generating, for at least one participant, an updated representation of virtual 3D video conference environment, the updated representation of virtual 3D video conference environment represents the updated 3D participant representation information for at least some of the multiple participants. Step 230 may include rendering images of the virtual 3D video conference environment for at least some of the multiple participants. Alternatively—step 230 may include generating input information (such as 3D model and/or one or more texture maps) to be fed to a rendering process.

Method 200 may also include step 240 of displaying, by a device of a participant of the multiple participants, an updated representation of the virtual 3D video conference environment, the updated representation may be associated with the participant.

Method 200 may include step 250 of transmitting the updated representation of virtual 3D video conference environment to at least one device of at least one participant.

The multiple participants may be associated with multiple participant devices, wherein the receiving and determining may be executed by at least some of the multiple participant devices. Any step of method 200 may be executed by at least some of the multiple participant device or by another computerized system.

The multiple participants may be associated with multiple participant devices, wherein the receiving and determining may be executed by a computerized system that differs from any of the multiple participant devices.

Method 200 may include one of more additional steps—collectively denoted 290.

The one or more additional steps may include at least one out of:
a. Determining a field of view of a third participant within the virtual 3D video conference environment.
b. Setting a third updated representation of the virtual 3D video conference environment that may be sent to a third participant device to reflect the field of view of the third participant.
c. Receiving initial 3D participant representation information for generating the 3D representation of the participant under different circumstances. The different circumstances may include at least one out of (a) different image acquisition conditions (different illumination and/or collection conditions), (b) different directions of gaze, (c) different expressions, and the like.
d. Receiving in run time, circumstances metadata; and amending, in real time, the updated 3D participant representation information based on the circumstances metadata.
e. Repetitively selecting for each participant, a selected 3D model out of multiple 3D models of the participant.
f. Repetitively smoothing a transition from one selected 3D model of the participant to another 3D model of the participant.
g. Selecting an output of at least one neural network of the multiple neural networks based on a required resolution.
h. Receiving or generating participants appearance information about head poses and expressions of the participants.
i. Determining the updated 3D participant representation information to reflect the participant appearance information.
j. Determine a shape of each of the avatars that represent the participants.
k. Determining relevancy of segments of updated 3D participant representation information.
l. Selecting which segments to transmit, based on the relevancy and available resources.
m. Generating a 3D model and one or more texture maps of 3D participant representation information of a participant.
n. Estimating 3D participant representation information of one or more hidden areas of a face of a participant.
o. Estimating 3D model hidden areas and one or more hidden parts texture maps.
p. Determining a size of the avatar.
q. Receiving audio information regarding audio from the participants and appearance information.
r. Synchronizing between the audio and the 3D participant representation information.
s. Estimating face expressions of the participants based on audio from the participants.
t. Estimating movements of the participants.

The receiving of the 3D participant representation information may be done during an initialization step.

The initial 3D participant representation information may include an initial 3D model and one or more initial texture maps.

The 3D participant representation information may include a 3D model and one or more texture maps.

The 3D model may have separate parameters for shape, pose and expression.

Each of the one or more texture maps may be selected and/or augmented based on at least one out of shape, pose and expression.

Each of the one or more texture maps may be selected and/or augmented based on at least one out of shape, pose, expression and angular relationship between a face of the participant and an optical axis of a camera that captures an image of face of the participant.

The determining, for each participant, of the updated 3D participant representation information may include at least one of the following:
a. Using one or more neural networks for determining the updated 3D participant representation information.
b. Using multiple neural networks for determining the updated 3D participant representation information, wherein different neural networks of the multiple neural networks may be associated with different circumstances.
c. Using multiple neural networks for determining the updated 3D participant representation information, wherein different neural networks of the multiple neural networks may be associated with different resolutions.

The updated representation of the virtual 3D video conference environment may include an avatar per participant of the at least some of the multiple participants.

A direction of gaze of an avatar within the virtual 3D video conference environment may represent a spatial relationship between a (a) direction of gaze of a participant that may be represented by the avatar and (b) a representation of the virtual 3D video conference environment displayed to the participant.

The direction of gaze of an avatar within the virtual 3D video conference environment may be agnostic to an optical axis of a camera that captured a head of the participant.

An avatar of a participant within the updated representation of the virtual 3D video conference environment may appear in the updated representation of the virtual 3D video conference environment as being captured by a virtual camera located on a virtual plane that crosses the eyes of the first participant. Accordingly—the virtual camera and the eye may be located, for example, at the same height.

The updated 3D participant representation information may be compressed.

The updated representation of the virtual 3D video conference environment may be compressed.

The generating of the 3D model and one or more texture maps may be based on images of the participant that were acquired under different circumstances.

The different circumstances may include different viewing directions of a camera that acquired the images, different poses, and different expressions of the participant.

The estimating of the 3D participant representation information of one or more hidden areas may be executed by using one or more generative adversarial networks.

The determining, for each participant, of the updated 3D participant representation information may include at least one out of:
a. Applying a super-resolution technique.
b. Applying noise removal.
c. Changing an illumination condition.
d. Adding or changing wearable item information.
e. adding or changing make up information.

The updated 3D participant representation information may be encrypted.

The updated representation of virtual 3D video conference environment may be encrypted.

The appearance information may be about head poses and expressions of the participants and/or be about lip movements of the participants.

The estimating face expressions of the participants based on audio from the participants may be executed by a neural network trained to map audio parameters to face expression parameters.

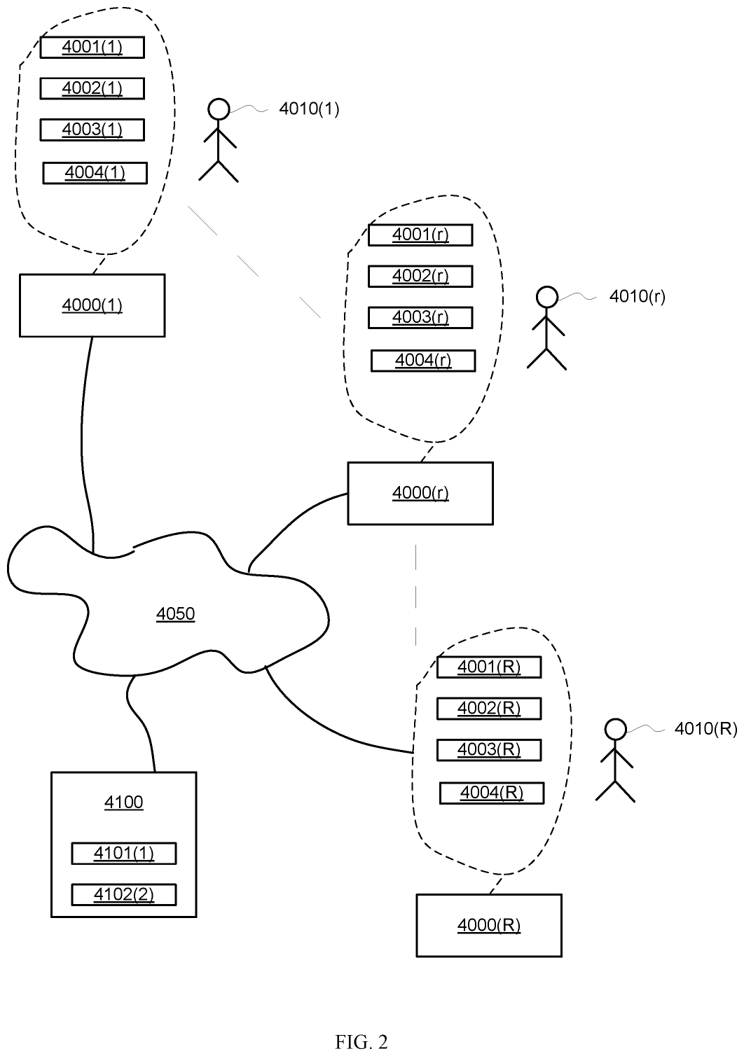

FIG. 2 illustrates an example of a computational environment that include users devices 4000(1)-4000(R) of users 4010(1)-4010(R). Index r ranges between 1 and R, R being a positive integer. The r'th user device 4000(r) may be any computerized device that may include one or more processing circuit 4001(r), a memory 4002(r), a man machine interface such as a display 4003(r), and one or more sensors such as camera 4004(r). The r'th user 4010(r) is associated with (uses) the r'th user device 4000(r). The camera may belong to the man machine interface.

The users devices 4000(1)-4000(R) and a remote computerized system 4100 may communicate over one or more networks such as network 4050. The one or more networks may be any type of networks—the Internet, a wired network, a wireless network, a local area network, a global network, and the like.

The remote computerized system may include one or more processing circuits 4101(1), a memory 4101(2), and may include any other component.

Any one of the users devices 4000(1)-4000(R) and a remote computerized system 4100 may participate in the execution of any method illustrated in the specification. Participate means executing at least one step of any of said methods.

Any processing circuit may be used—one or more network processors, non-neural network processors, rendering engines, image processors and the like.

One or more neural networks may be located at a user device, at multiple users devices, at a computerized system outside any of the user devices, and the like.

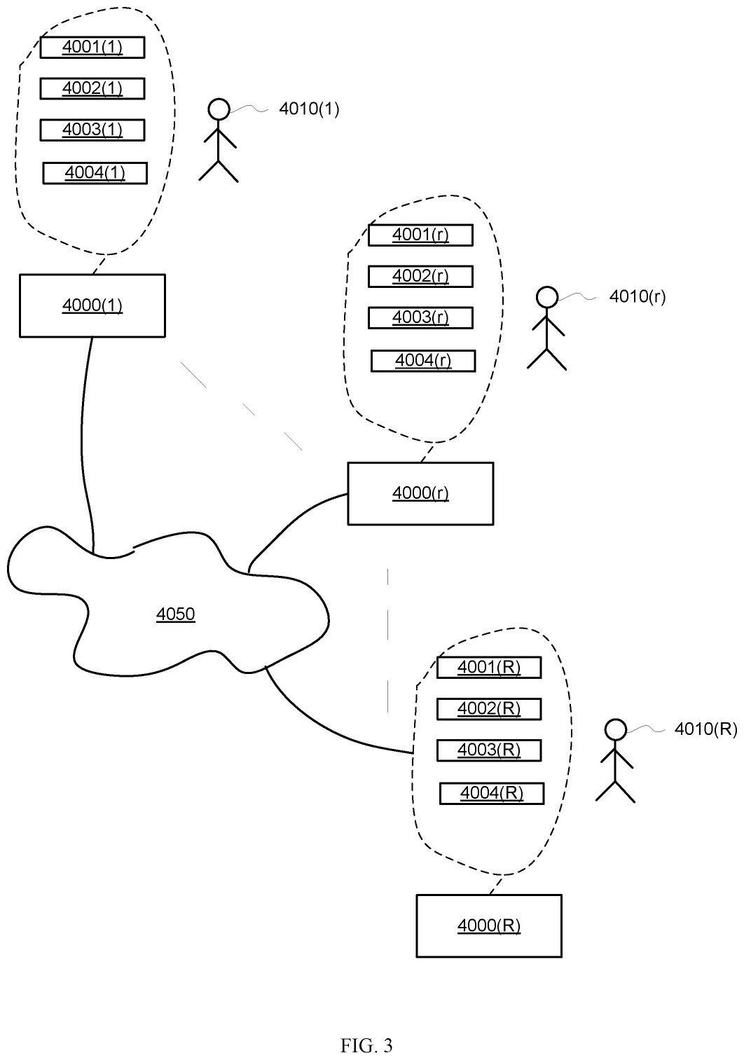

FIG. 3 illustrates an example of a computational environment that include users devices 4000(1)-4000(R) of users 4010(1)-4010(R). Index r ranges between 1 and R, R being a positive integer. The r'th user device 4000(r) may be any computerized device that may include one or more processing circuit 4001(r), a memory 4002(r), a man machine interface such as a display 4003(r), and one or more sensors such as camera 4004(r). The r'th user 4010(r) is associated with (uses) the r'th user device 4000(r).

The users devices 4000(1)-4000(R) may communicate over one or more networks such as network 4050.

Any one of the users devices 4000(1)-4000(R) may participate in the execution of any method illustrated in the specification. Participate means executing at least one step of any of said methods.

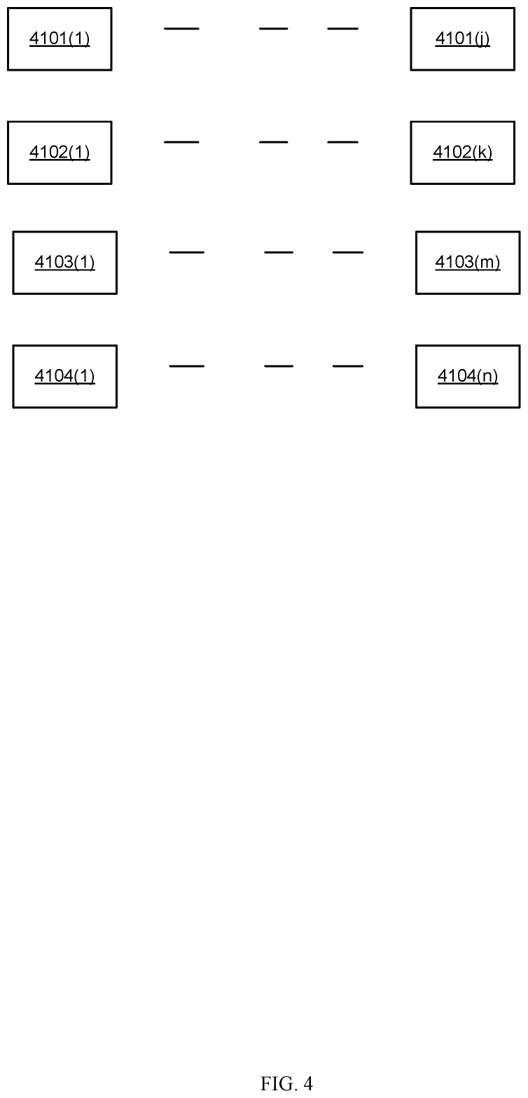

FIG. 4 illustrates an example of various data structures. The data structures may include user avatars 4101(1)-4101(j), texture maps 4102(1)-4102(k), 3D models 4103(1)-4103(m), 3D representations of objects 4104(1)-4104(n), and any mapping or other data structures mentioned in the application.

Any user may be associated with one or more data structure of any type—avatar, 3D model, texture map, and the like.

Some of the examples refer to a virtual 3D video conference environment such as a meeting room, restaurant, cafe, concert, party, external or imaginary environment in which the users are set. Each participant may choose or be otherwise associated with a virtual or actual background and/or may select or otherwise receive any virtual or actual background in which avatars related to at least some of the participants are displayed. The virtual 3D video conference environment may include one or more avatars that represents one or more of the participants. The one or more avatars may be virtually located within the virtual 3D video conference environment. One or more features of the virtual 3D video conference environment (that may or may not be related to the avatars) may differ from one participant to another.

Either the full body, the upper part of the body or just the face of the users are seen in this environment—thus an avatar may include full body of a participant, the upper part of a body of the participant body or just the face of the participant.

Within the virtual 3D video conference environment there may be provided an improved visual interaction between users that may emulate the visual interaction that exists between actual users that are actually positioned near each other. This may include creating or ceasing to have eye-contact, expressions directed at specific users and the like.

In a video conference call between different users, each user may be provided with a view of one or more other users—and the system may determine (based on gaze direction and the virtual environment)—where the user looks (for example at one of the other users—at none of the users, at a screen showing a presentation, at a whiteboard, etc.)—and this is reflected by the virtual representation (3D model) of the user within the virtual environment—so that other users may determine where the user is looking.

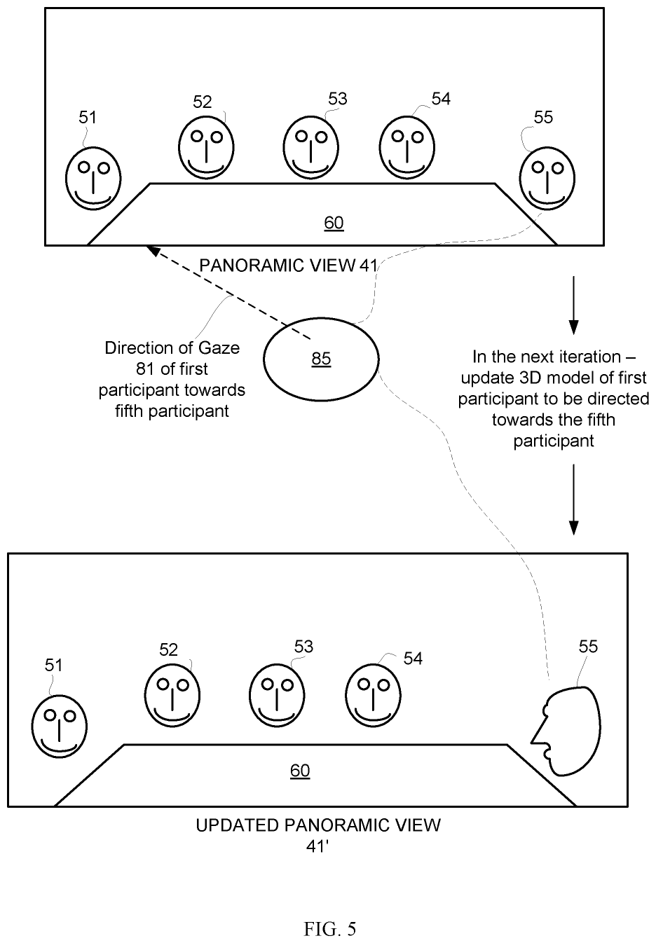

FIG. 5 illustrates an example of a process for amending a direction of view of an avatar of a part of a participant according to a direction of gaze of the participant. The upper part of FIG. 5 is a virtual 3D video conference environment—represented by a panoramic view 41 of five participants 51, 52, 53, 54 and 55 sitting near table 60. All participants face the same direction—the screen.

In the lower image the avatar of the fifth participant faces the avatar of first participant—as the fifth participant was detected to look at the 3D model of the first participant within the environment as presented to the fifth participant.

Tracking the user's eyes and gaze direction may also be used to determine the direction in which the user is looking (direction of gaze) and at which person or object the user is looking. This information can be used to rotate the avatar's head and eyes so that in the virtual space it also appears as if the user is looking at the same person or object as in the real world.

Tracking the user's head pose and eye gaze may also be used to control the virtual world's appearance on the user's screen. For example, if the user looks at the right side of the screen, the point of view of the virtual camera may move to the right, so that the person or object at which the user is looking is located at the center of the user's screen.

The rendering of a user's head, body, and hands from a certain point of view that is different than the original point of view of the camera may be done in different ways, as described below:

In one embodiment, a 3D model and texture maps are created before the beginning of the meeting and this model is then animated and rendered at run time according to the user's pose and expressions that are estimated from the video images.

A texture map is a 2D image in which each color pixel represents the red, green and blue reflectance coefficients of a certain area in the 3D model. An example of a texture map is shown in FIG. 20. Each color pixel in the texture map corresponds to certain coordinates within a specific polygon (e.g., triangle) on the surface of the 3D model.

Generally, each pixel in the texture map has an index of the triangle to which it is mapped and 3 coordinates defining its exact location within the triangle.

A 3D model composed of a fixed number of triangles and vertices may be deformed as the 3D model changes. For example, a 3D model of a face may be deformed as the face changes its expression. Nevertheless, the pixels in the texture map correspond to the same locations in the same triangles, even though the 3D locations of the triangles change as the expression of the face changes.

Texture maps may be constant or may vary as a function of time, expression or of viewing angle. In any case, the correspondence of a given pixel in a texture map and a certain coordinate in a certain triangle in the 3D model doesn't change.

In yet another embodiment, a new view is created based on a real-time image obtained from a video camera and the position of the new point of view (virtual camera).

In order to best match between the audio and the lip movement and facial expressions, the audio and video that is created from the rendering of the 3D models based on the pose and expressions parameters are synchronized. The synchronization may be done by packaging the 3D model parameters and the audio in one packet corresponding to the same time frame or by adding time stamps to each of the data sources.

To further improve the natural appearance of the rendered model, a neural network may be trained to estimate the facial expression coefficients based on the audio. This can be done by training the neural network using a database of videos of people talking and the corresponding audio of this speech. The videos may be of the participant that should be represented by an avatar or of other people. Given enough examples, the network learns the correspondence between the audio (i.e. phonemes) and the corresponding face movements, especially the lip movements. Such a trained network would enable to continuously render the facial expressions and specifically the lip movements even when the video quality is low or when part of the face is obstructed to the original video camera.

In yet another embodiment, a neural network can be trained to estimate the audio sound from the lip and throat movements or from any other facial cues, as is done by professional lip readers. This would enable to create or improve the quality of the audio when the audio is broken or when there are background noises that reduce its quality.

In yet another embodiment a neural network is trained to compress audio by finding a latent vector of parameters from which the audio can be reconstructed at a high quality. Such a network could serve to compress audio at a lower bit rate than possible with standard audio compression methods for a given audio quality or obtain a higher audio quality for a given bit rate.

Such a network may be trained to compress the audio signal to a fixed number of coefficients, subject to the speech being as similar as possible to the original speech under a certain cost function.

The transformation of the speech to a set of parameters may be a nonlinear function and not just a linear transformation as is common in standard speech compression algorithms. One example would be that the network would need to learn and define a set of base vectors which form a spanning set of spoken audio.

The parameters then would be the vectorial coefficients of the audio as spanned by this set.

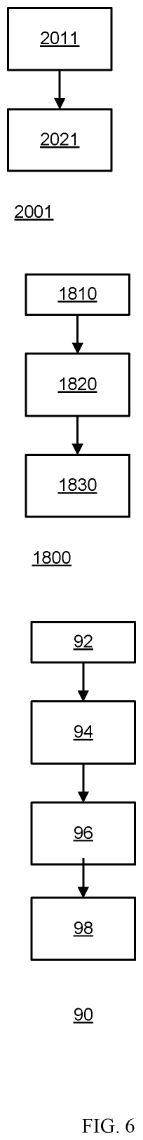

FIG. 6 illustrates method 2001.

Method 2001 is for conducting a 3D video conference between multiple participants, the method may include steps 2011 and 2021.

Step 2011 may include determining, for each participant, updated 3D participant representation information within the virtual 3D video conference environment, which represents participant. The determining may be based on audio generated by the participants and appearance information about appearance of the participants.

Step 2021 may include generating, for at least one participant, an updated representation of virtual 3D video conference environment, the updated representation of virtual 3D video conference environment represents the updated 3D participant representation information for at least some of the multiple participants. For example, any movement by the participant may expose or collude parts of the environment. Additionally, movements by participant may affect lighting in the room as the movements may modify the exposure to light of different parts of the environment.

The method may include matching between the audio from a certain participant and appearance information of a certain participant.

The appearance information may be about head poses and expressions of the participants.

The appearance information may be about lip movements of the participants.

Communications System Based on the 3D Models.

During the communication session, i.e., a 3D video conference call between several users, a 2D or 3D camera (or several cameras) grabs videos of the users. From these videos a 3D model (for example—the best fitting 3D model) of the user may be created at a high frequency, e.g., at a frame rate of 15 to 120 fps.

Temporal filters or temporal constraints in the neural network may be used to assure a smooth transition between the parameters of the model corresponding to the video frames in order to create a smooth temporal reconstruction and avoid jerkiness of the result.

The real-time parametric model together with the reflectance map and other maps may be used to render a visual representation of the face and body that may be very close to the original image of the face and body in the video.

Since this may be a parametric model, it may be represented by a small number of parameters. Typically, less than 300 parameters may be used to create a high-quality model of the face including each person's shape, expression and pose.

These parameters may be further compressed using quantization and entropy coding such as a Huffman or arithmetic coder.

The parameters may be ordered according to their importance and the number of parameters that may be transmitted and the number of bits per parameter may vary according to the available bandwidth.

In addition, instead of coding the parameters' values, the differences of these values between consecutive video frames may be coded.

The model's parameters may be transmitted to all other user devices directly or to a central server. This may save a lot of bandwidth as instead of sending the entire model of the actual high-quality image during the entire conference call—much fewer bits representing the parameters may be transmitted. This may also guarantee a high quality of the video conference call, even when the current available bandwidth may be low.

Transmitting the model parameters directly to the other users instead of via a central server may reduce the latency by about 50%.

The other user devices may reconstruct the appearance of the other users from the 3D model parameters and the corresponding reflectance maps. Since the reflectance maps, representing such things as a person's skin color change very slowly, they may be transmitted only once at the beginning of the session or at a low updating frequency according to changes that occur in these reflectance maps.

In addition, the reflectance maps and other maps may be updated only partially, e.g., according to the areas that have changed or according to semantic maps representing body parts. For example, the face may be updated but the hair or body that may be less important for reconstructing emotions may not be updated or may be updated at a lower frequency.

In some cases, the bandwidth available for transmission may be limited. Under such conditions, it may be useful to order the parameters to transmit according to some prioritization and then transmit the parameters in this order as the available bandwidth allows. This ordering may be done according to their contribution to the visual perception of a realistic video. For example, parameters related to the eyes and lips may have higher perceptual importance than those related to cheeks or hair. This approach would allow for a graceful degradation of the reconstructed video.

The model parameters, video pixels that may be not modelled and audio may be all synchronized.

As a result, the total bandwidth consumed by the transmission of the 3D model parameters may be several hundred bits per second and much lower than the 100 kbps-3 Mbps that may be typically used for video compression.

A parametric model of the user's speech may also be used to compress the user's speech beyond what may be possible with a generic speech compression method. This would further reduce the required bandwidth required for video and audio conferencing. For example, a neural network may be used to compress the speech into a limited set of parameters from which the speech can be reconstructed. The neural network is trained so that the resulting decompressed speech is closest to the original speech under a specific cost function. The neural network may be a nonlinear function, unlike linear transformations used in common speech compression algorithms.

The transmission of bits for reconstructing the video and audio at the receiving end may be prioritized so that the most important bits may be transmitted or receive a higher quality of service. This may include but may not be limited to prioritizing audio over video, prioritizing of the model parameters over texture maps, prioritizing certain areas of the body or face over others, such as prioritizing information relevant to the lips and eyes of the user.

An optimization method may determine the allocation of bitrate or quality of service to audio, 3D model parameters, texture maps or pixels or coefficients that may be not part of the model in order to ensure an overall optimal experience. For example, as the bitrate is reduced, the optimization algorithm may decide to reduce the resolution or update frequency of the 3D model and ensure a minimal quality of the audio signal.

The users may be provided with one or more views of the virtual 3D video conference environment—whereas the user may or may not select the field of view—for example, a field of view that includes all of the other users or only one or some of the users, and/or may select or may view one or some objects of the virtual 3D video conference environment such as TV screens, whiteboards, etc.

When combining the video pixels and the rendered 3D models, the areas corresponding to the model, the areas corresponding to the video pixels, or both may be processed so that the combination may appear natural and a seam between the different areas would not be apparent. This may include but may be not limited to relighting, blurring, sharpening, denoising or adding noise to one or some of the image components so that the whole image appears to originate from one source.

Each user may use a curved screen or a combination of physical screens to that the user in effect can see a panoramic image showing a 180 or 360 degree view (or any other angular range view) of the virtual 3D video conference environment and/or a narrow field of view image focusing on part of the virtual 3D video conference environment such as a few people, one person, only part of a person, i.e. the person's face, a screen or a whiteboard or any one or more parts of the virtual 3D video conference environment.

The user will be able to control the part or parts of the narrow field of view image or images by using a mouse, a keyboard, a touch pad or a joystick or any other device that allows to pan and zoom in or out of an image.

The user may be able to focus on a certain area in the virtual 3D video conference environment (for example a panoramic image of the virtual 3D video conference environment) by clicking on the appropriate part in the panoramic image.

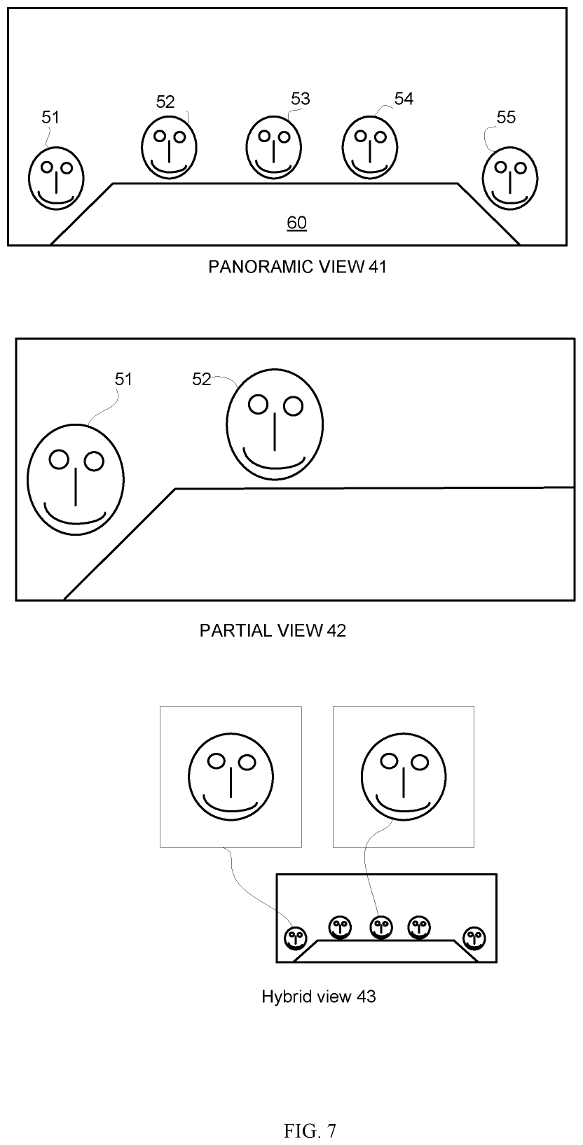

FIG. 7 illustrates an example of a panoramic view 41 of the virtual 3D video conference environment populated by five participants and a partial view 42 of the some of the participants within the virtual 3D video conference environment. FIG. 7 also illustrates a hybrid view 43 that includes a panoramic view (or a partial view) and expanded images of faces of some of the participants.

The user may be able to pan or zoom using head, eyes, hands, or body gestures. For example, by looking at the right or left part of the screen, the focus area may move to the left or right, so it appears at the center of the screen, and by leaning forward or backwards the focus area may zoom in or out.

The 3D model of the person's body may also assist in correctly segmenting the body and the background. In addition to the model of the body, the segmentation method will learn what objects may be connected to the body, e.g., a person may be holding a phone, pen or paper in front of the camera. These objects will be segmented together with the person and added to the image in the virtual environment, either by using a model of that object or by transmitting the image of the object based on a pixel level representation. This may be in contrast to existing virtual background methods that may be employed in existing video conferencing solutions that may not show objects held by users as these objects are not segmented together with the person but rather as part of the background that has to be replaced by the virtual background.

Segmentation methods typically use some metric that needs to be exceeded in order for pixels to be considered as belonging to the same segment. However, the segmentation method may also use other approaches, such as Fuzzy Logic, where the segmentation method only outputs a probability that pixels belong to the same segment. If the method detects an area of pixels with a probability that makes it unclear if it and it is not sure whether the area should be segmented as part of the foreground or background, the user may be asked how to segment this area.

As part of the segmentation process, objects such as earphones, cables connected to the earphones, microphones, 3D glasses or VR headsets may be detected by a method. These objects may be removed in the modelling and rendering processes so that the image viewed by viewers does not include these objects. The option to show or eliminate such objects may be selected by users or may be determined in any other manner—for example based on selection previously made by the user, by other users, and the like.

If the method detects more than one person in the image, it may ask the user whether to include that person or people in the foreground and in the virtual 3D video conference environment or whether to segment them out of the image and outside of the virtual 3D video conference environment.

In addition to using the shape or geometrical features of objects in order to decide whether they may be part of the foreground or background, the method may also be assisted by knowledge about the temporal changes of the brightness and color of these objects. Objects that do not move or change have a higher probability of being part of the background, e.g., part of the room in which the user may be sitting, while areas where motion or temporal changes may be detected may be considered to have a higher probability of belonging to the foreground. For example, a standing lamp would not be seen as moving at all and it would be considered part of the background. A dog walking around the room would be in motion and considered part of the foreground, In some cases periodic repetitive changes or motion may be detected, for example where a fan rotates, and these areas may be considered to have a higher probability of belonging to the background.

The system will learn the preferences of the user and use the feedback regarding which objects, textures or pixels may be part of the foreground and which may be part of the background and use this knowledge in order to improve the segmentation process in the future. A learning method such as a Convolutional Neural Network or other machine learning method may learn what objects may be typically chosen by users as parts of the foreground and what objects may be typically chosen by users as part of the background and use this knowledge to improve the segmentation method.

The processing of this system may be performed on the user's device such as a computer, a phone or a tablet or on a remote computer such as a server on the cloud. The computations may also be divided and/or shared between the user's device and a remote computer, or they may be performed on the user's device for users with appropriate hardware and on the cloud (or in any other computation environment) for other users.

The estimation of the body and head parameters may be done based on compressed or uncompressed images. Specifically, they can be performed on compressed video on a remote computer such as a central computer on the cloud or another user's device. This would allow normal video conferencing systems to send compressed video to the cloud or another user's computer where all the modelling, rendering and processing would be performed.

Gaze Detection in Video Conferencing

Video conferencing is a leading method for executing meetings of all kinds. This is especially true with the globalization of working environments and has been enhanced with the appearance of the Covid-19 virus.

With the increase of importance of video conferencing systems, new methods of implementing them are being introduced. These include 3D environments, where the video conference appears to be held in a virtual setting. The participants also appear as 3D figures within the virtual environment, usually represented as avatars. In order for this kind of system to give participants a sensation of a real face-to-face meeting, it is important to understand where each participant is looking and to have the avatar look at the same place and with the same head orientation and movements as detailed below.

Prior art solutions are limited to understanding of where viewers look at the screen.

DOF—Degrees of Freedom

6 DOF—relative to a coordinate system, a person's head can have 6 degrees of freedom. Three of these are the X, Y and Z location of a predefined point in the head (e.g., the tip of the nose or the right extreme point of one of the eyes, etc.) The other three degrees of freedom are rotations around these axes. These are often known as Pitch, Yaw and Roll.

8 DOF—in addition to the 6 DOF, there are two additional degrees of freedom that help define a person's gaze. These additional degrees of freedom are necessary because the eyes do not necessarily look directly forward at all times.

Therefore, one needs to add two rotations of the eyes (Pitch and Yaw). In the most general case, one can say that each eye will have different values for these parameters.

Therefore, the most accurate description would actually be 10 DOF but for the sake of the document, only 8 DOF will be dealt with. In case a person looks at objects that are not in the immediate vicinity of the eyes, one can assume that both eyes have the same values for these parameters. The reduction from 10 DOF to 8 DOF can be done by averaging the values for both eyes or by taking the values of only one of the eyes. All that is written below can be applied to 10 DOF models.

There are known methods for determining where in the screen is the participant looking at. See for example http://developer.tobiipro.com/commonconcepts/calibration.html

Solutions such as these only deal with understating at which point in the screen the viewer is looking. They are accomplished by calibrating the sight of the viewer as seen by the camera, with known coordinates of the screen.

Information about the screen size, or specifically the size of the window that is viewed by the viewer can be supplied by all operating systems or can be inferred by information about the screen size and window attributes within the screen.

In order to calculate the line of sight, one needs to find the 8 DOF parameters of the participant and combine that with the point on the screen with the participant is looking at.

The 6 DOF parameters can be obtained in the following manner: X and Y are relative to the camera's coordinates. Z can be obtained by one of the following methods:
a. For calibration purposes, ask the participant to sit at a defined distance from the camera. This is a one-time process. Following this, Z can be calculated by changes in the size of the head as viewed by the camera.
b. Use a depth camera. These are more and more ubiquitous nowadays.
c. Infer the participant's distance from the camera by the size of the participant's head as captured by the camera and compared to an average human's head size. Average numbers can be obtained, for example, here: https://en.wikipedia.org/wiki/Human_head
d. Assume that the participant is located at a certain distance from the camera (e.g., 55 cm)

The three additional DOF are then easily obtained. This involves finding the Euclidean matrix which describes the movement of the head and is well known in computer graphics and in other areas.

The additional DOF for the eyes can then be found by comparing the pupil locations relative to the center of the eyes.

In order to calculate the line of sight, one assumes a virtual pinhole camera (VCV) located at the geometrical point which is on the participant's face between the participant's eyes. A line is then calculated which joins that virtual camera with the point on the screen the viewer is looking at. Note that, since we are dealing with a virtual 3D video conferencing setting, this virtual camera is also used as a virtual camera (VCP) when deciding what to present to the viewer on the viewer's screen from within the 3D environment. Therefore, the line of sight is also the line of sight within the 3D environment. Under some circumstances and in order to reduce the amount of changes of what is presented to the viewer, VCP may be less prone to movements than VCV and may be located at a slightly different location. Even in these cases, the location of VCP is known and it is straightforward to translate the viewers line of sight from VCV coordinates to a line of sight in the VCP coordinates.

Finding the line of sight is followed by determining what is the viewer looking at. This can be answered by finding the opaque object along the line of sight which is closest to VCV along the line of sight. In order to reduce possible miscalculations, it may be possible to assume that the viewer is looking at a face along or closest to the line of sight.

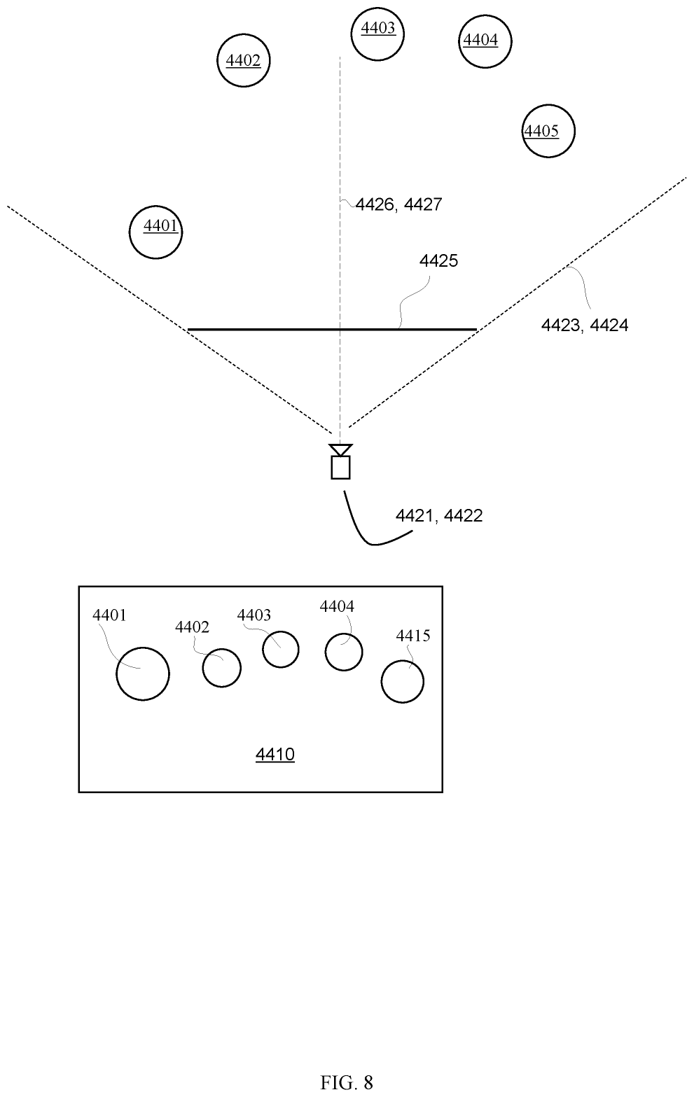

FIG. 8 illustrates an example where the first and second cameras VCV 4421 and VCP 4422 are mutually aligned. VCV 4421 has an optical axis 4426 and a VCV field of view 4423. VCP 4422 has an optical axis 4427 and a VCP field of view 4424.

FIG. 8 also illustrates avatars 4401, 4402, 4403, 4404 and 4405 of five participants within the virtual 3D video conference environment (V3DVCE), the display 4425 (as virtually appears in the V3DVCE), and an image 4410 that illustrates the displayed representation of the V3DVCE in which the five avatars are illustrated.

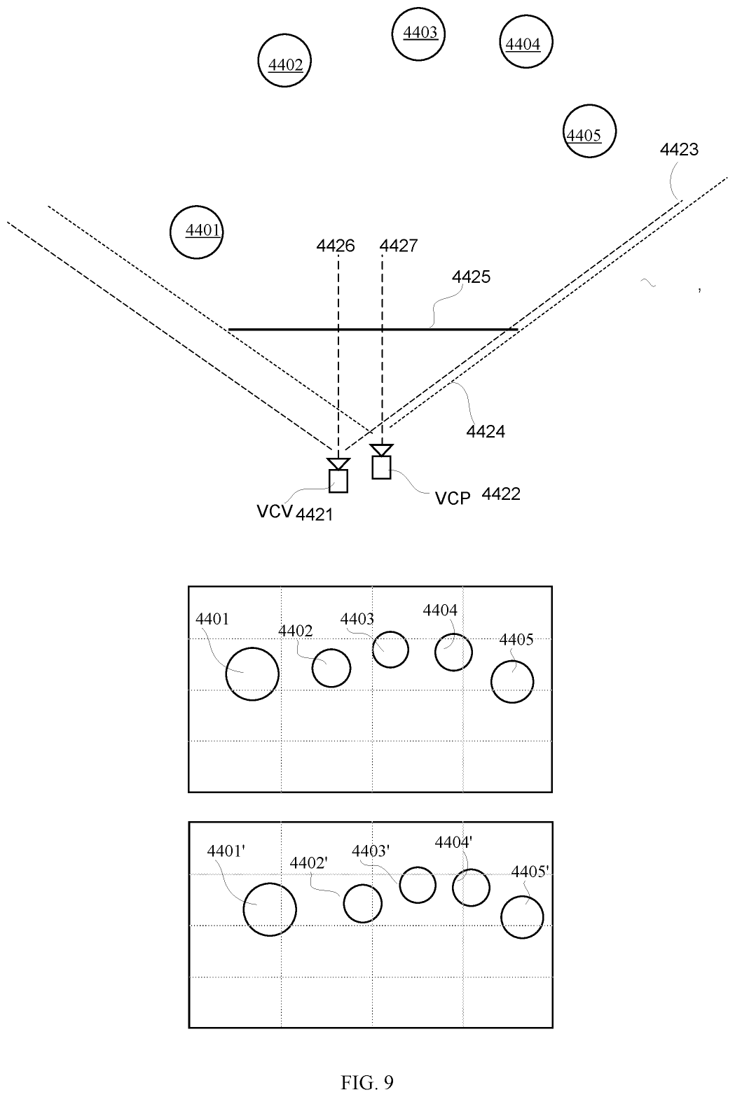

FIG. 9 illustrates an example where the first and second cameras VCV 4421 and VCP 4422 are misaligned but have their optical axes and field of views spaced apart but parallel to each other.

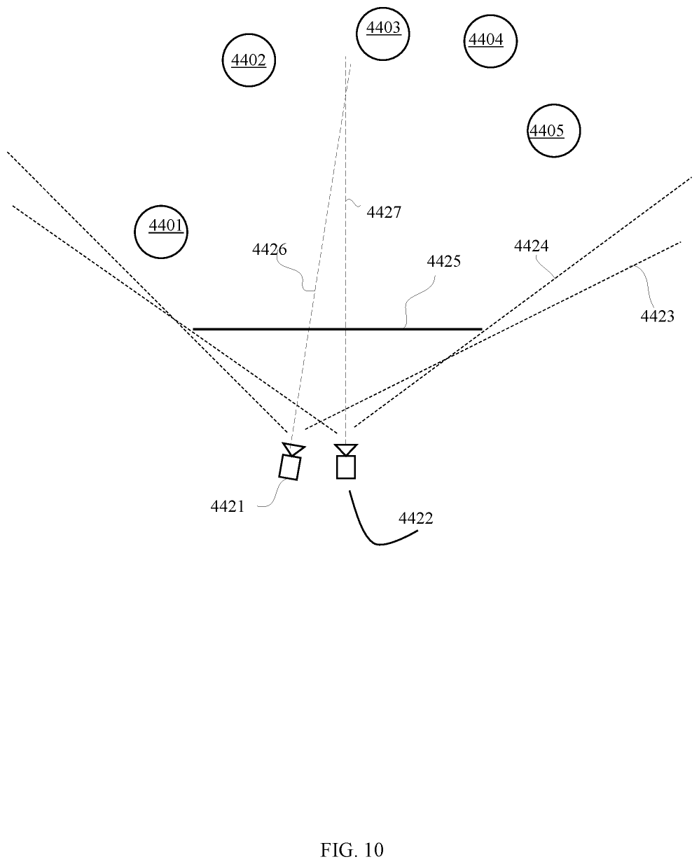

FIG. 10 illustrates an example where the first and second cameras VCV 4421 and VCP 4422 are misaligned but have their optical axes and field of views spaced apart and non-parallel to each other. Misalignment between the VCV and the VCP may occur. Misalignment between them may mean that the optical axis of the VCV is misaligned with the optical axis of the VCP. When this occurs, a gaze related object (or a part of said gaze related object) that can be fully seen by one camera, may be at least partially concealed from the other camera.

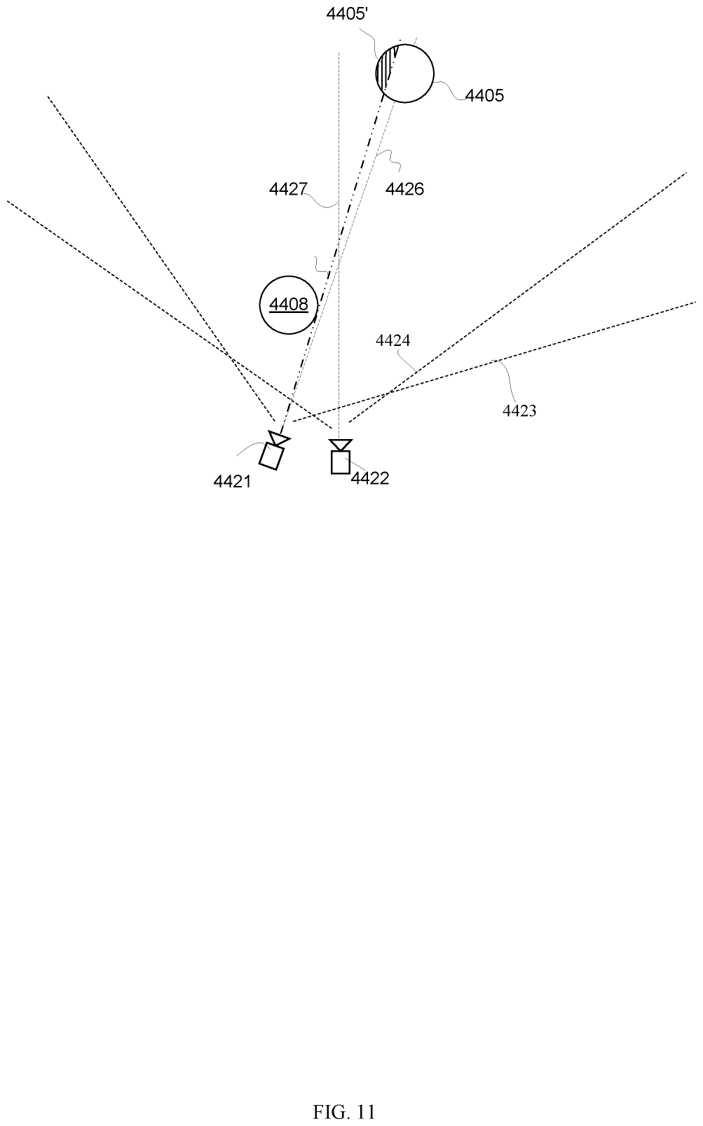

FIG. 11 illustrates an example where the first and second cameras VCV 4421 and VCP 4422 are misaligned, their optical axes and field of views spaced apart and non-parallel to each other, an avatar 4405 (example of a gaze related object) is fully seen by VCP 4422 and is partially concealed (part 4405′ is not shown)—due to the presence of another gaze related object 4408.

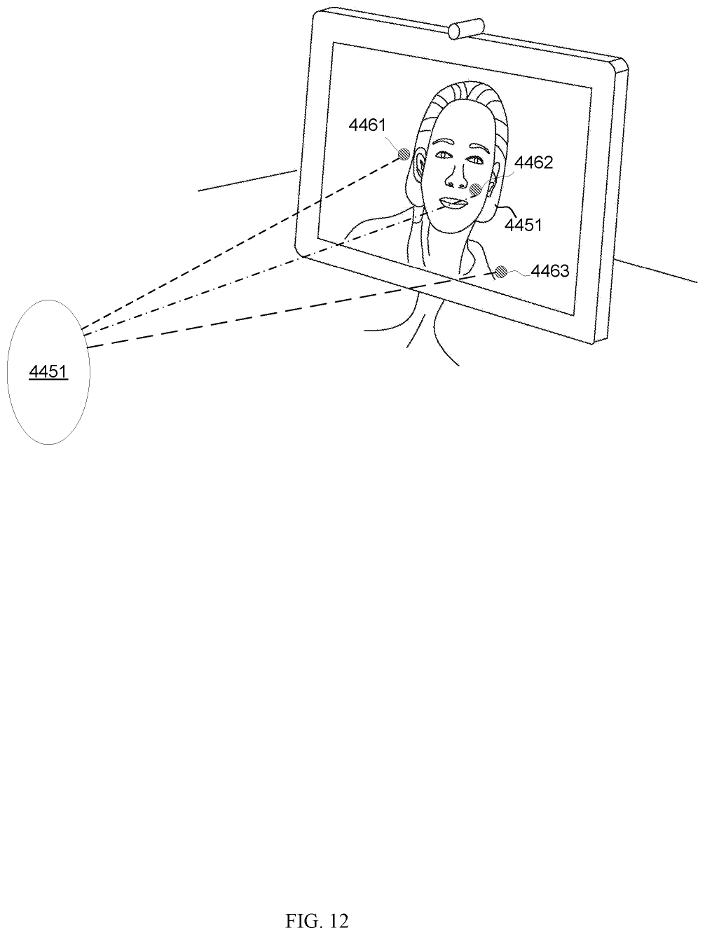

FIG. 12 illustrates a participant 4451 that looks at three different points of time, at points 4461, 4462 and 4463 within the V3DVCE, point 4464 is positioned on the face of avatar 4451, points 4461 and 4463 are located in proximity to avatar 4451—and the method may conclude that the participant looks at the avatar 4451.

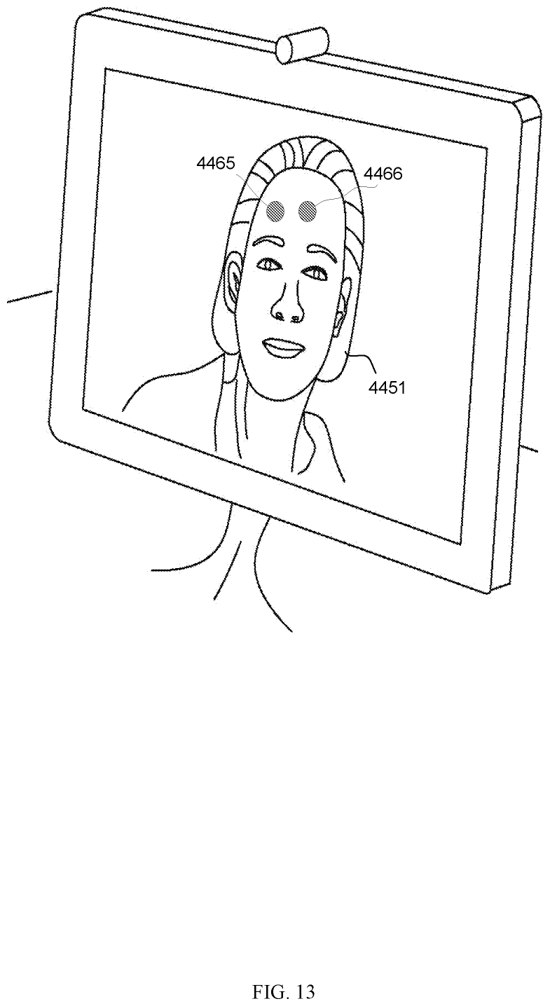

FIG. 13 illustrates different points of gaze of a participant (appearing as points 4465 and 4465 on an avatar 4451 of another participant. The participant has its gaze oscillate between points 4465 and 4466 (on avatar 4451). By applying a temporal filter and/or smoothing—the gaze may be set (for purposes of generating the next displayed version of the V3DVCE) on one point—being one of the points, average point between points 4465 and 4466.

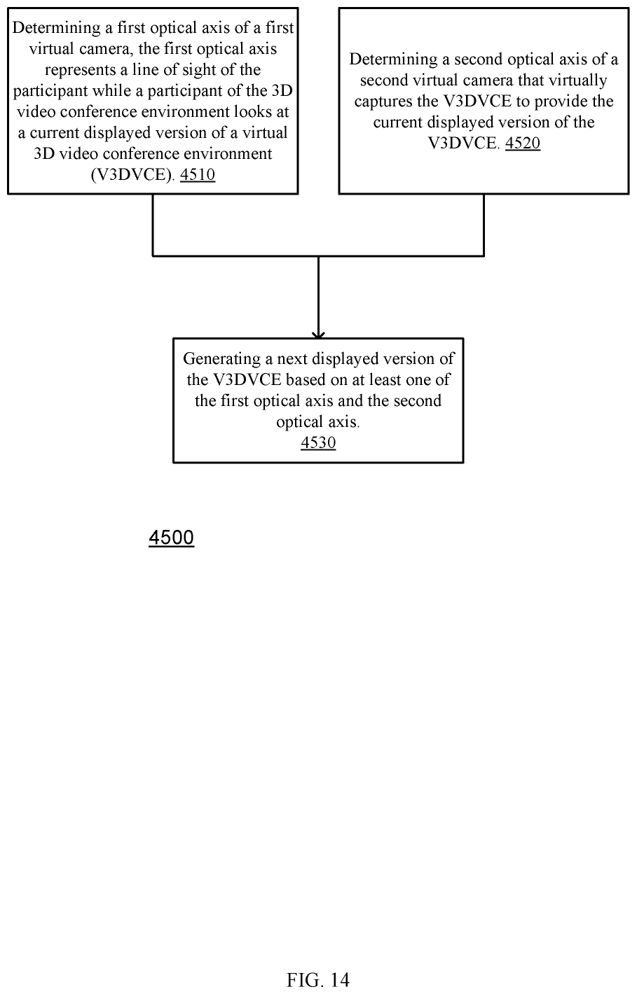

FIG. 14 illustrates method 4500 for virtual 3D video conference environment generation.

Method 4500 may start by steps 4510 and 4520.

Step 4510 may include determining a first optical axis of a first virtual camera, the first optical axis represents a line of sight of the participant while a participant of the 3D video conference environment looks at a current displayed version of a virtual 3D video conference environment (V3DVCE). A current displayed version of the V3DVCE is displayed on a display.

The first virtual camera may be virtually positioned at a geometrical point between both eyes of a participant and on a face of the participant.

Step 4510 may include at least one out of:
a. Applying a temporal filter on multiple intermediate determinations of the first optical axis, made during a certain time period.
b. Applying a smoothing operation on multiple intermediate determinations of the first optical axis, made during a certain time period.
c. Applying a temporal filter on multiple intermediate determinations of a second optical axis, made during the certain time period.

Step 4520 may include determining a second optical axis of a second virtual camera that virtually captures the V3DVCE to provide the current displayed version of the V3DVCE.

The V3DVCE may be displayed in correspondence to the second optical axis.

Steps 4510 and 4520 may be followed by step 4530 of generating a next displayed version of the V3DVCE based on at least one of the first optical axis and the second optical axis.

Steps 4510, 4520 and 4530 may be repeated multiple times—for example during the duration of the 3D video conference. Steps 4510, 4520, 4530 may be repeated each video frame, each multiple video frames, one to tens frames per second, once per second, once per multiple seconds, and the like.

Step 4530 may include at least one out of:
a. Comparing the second optical axis to the estimate of the line of sight of the participant within V3DVCE. The line of sight may have a first part outside the display.
b. The comparing may include calculating an estimate of the second optical axis outside the display.
c. Comparing the line of sight to the estimate of the second optical axis outside the display.
d. Determining an intersection pixel of the display that intersects with the first optical axis.
e. Searching for a potential object of interest that is virtually positioned within the V3DVCE in proximity to the line of sight within the V3DVCE, and determining a content of the next displayed version based on the potential object of interest. The potential object of interest may include an avatar. The potential object of interest may not be intersected by the line of sight.
f. Virtually amending the line of sight to virtually intersect with the potential object of interest.
g. Determining one or more gaze related objects. A gaze related object is an object that is located within a field of view of the participant, as represented by the direction of gaze of the participant.
h. Determining whether a gaze related object of the one or more gaze related objects at least partially conceals another gaze related object of the one or more gaze related objects. There may be an angular difference between the first optical axis and the second optical axis. The estimate of the first optical axis in the V3DVCE is an angular difference compensated estimate of the line of sight within the V3DVCE. Step 4530 may include compensating for an angular difference between the first optical axis and the second optical axis

The one or more gaze related objects may include:
a. At least one object that intersects with the estimate of the first optical axis in the V3DVCE.
b. At least one object that is a face of an avatar of a participant that is located in proximity to the estimate of the first optical axis in the V3DVCE.
c. At least one object of interest within in the V3DVCE.

In the foregoing specification, the embodiments of the disclosure have been described with reference to specific examples of embodiments of the disclosure. It will, however, be evident that various modifications and changes may be made therein without departing from the broader spirit and scope of the embodiments of the disclosure as set forth in the appended claims.

Generating a Sound Representation of a Virtual Environment from Multiple Sound Sources

The following text refers to a sound source. A sound source may be a participant of the virtual 3D video conference—or may differ from such a participant—for example may be a computerized device—such as but not limited to a computerized device of a participant.

Any reference to a participant of a virtual 3D video conference may be applied mutatis mutandis to a client.

A virtual 3D video conference environment (V3DVCE) is a non-limiting example of a virtual environment.

Any reference to clustering should be applied mutatis mutandis to grouping.

Any reference to a cluster should be applied mutatis mutandis to a group and/or should be applied mutatis mutandis to a sub-group.

Any reference to a server should be applied mutatis mutandis to a computerized system that has more computational resources from a mobile phone or another portable communication device of a participant. For example—the computerized system may include an multiple computers.

Participant responsibilities. The participant side which reconstructs the virtual environment is capable of creating a 3D sound environment. For this it needs to receive the audio stream of the different sources, their location and the orientation of the virtual environment. The participant can perform this reconstruction for multiple sound sources but, being on a device with limited resources, it is better to use some consolidation approach which would reduce the number of sound sources.

Server Responsibilities. The server has many resources. While, theoretically, it can prepare the fully reconstructed 3d sound track for the device, this may suffer from latency issues and also would mean a very expensive solution. This is especially true if there are many participants involved. Indeed, the problem lies in environments with many sound sources—possibly all participate also in the virtual environment not only as sources but also as players that want to receive a virtual experience of their own.

Therefore, the server prepares the sound sources in such a way that allows it to send different consolidated components to each participant.

There are two main assumptions:
a. The server knows the 3D location of each sound source at any given time. In the current solution, the server does not necessarily know the direction of the sounds.
b. The participant can process sounds coming from about one sixteenth of the sound sources plus five. So, for example, in a room with 64 participants, the device of each one should be able to process about nine sound sources.

The server clusters the sound sources into four groups (like k-means clustering): Gᵢ where i={0 . . . 3}. Each cluster group then goes through the same process where the sound sources inside it are clustered into four sub-groups SG_{i,j} where i,j={0 . . . 3}.

This process is repeated every t seconds. t should be in the order of 1 second.

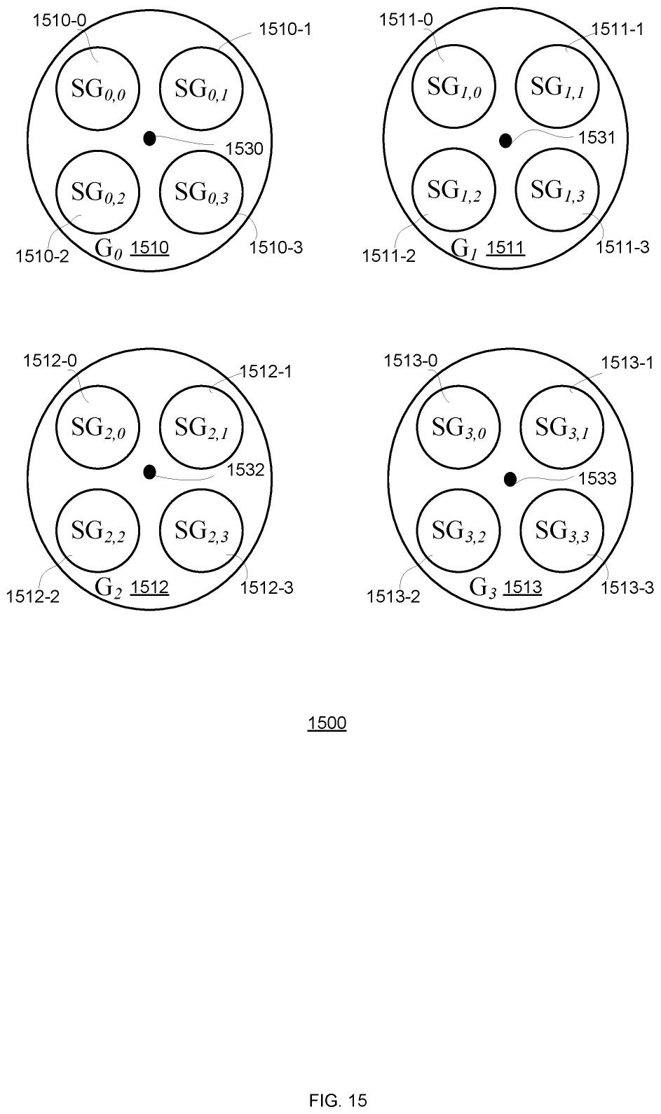

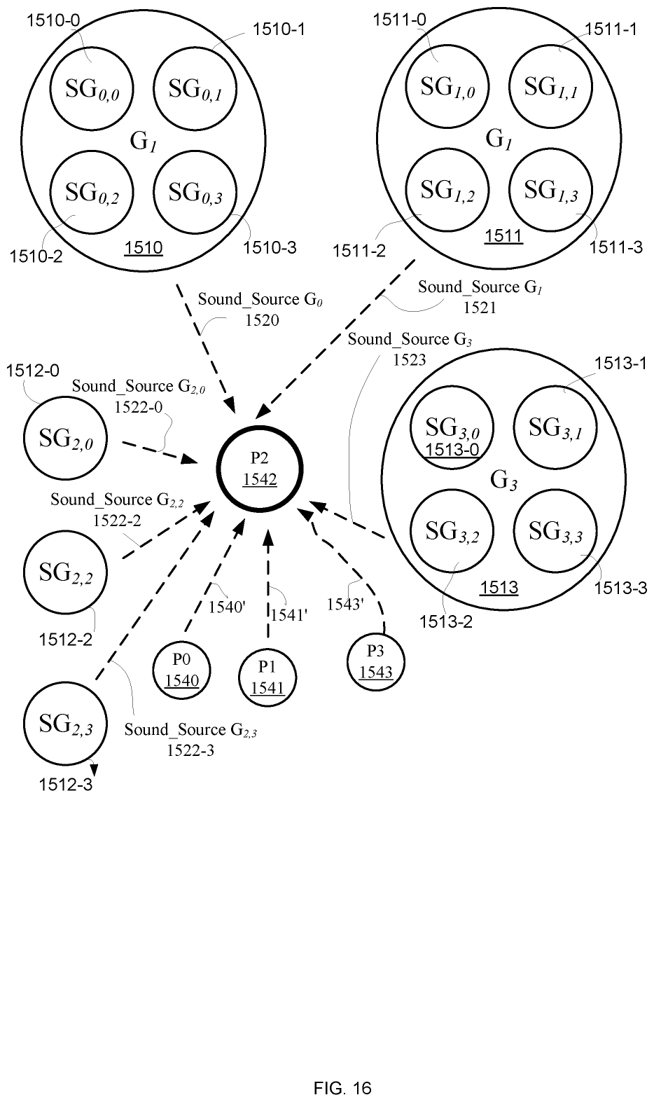

The following examples refer to the existence of four groups of users—each group includes four sub-groups of four users each. There may be provided any number of groups, any number of sub-groups and any number of participants per sub-group. There may be provided any relationship between the number of groups, the number of sub-groups and the number of participants per sub-group. The number of sub-groups of one group may differ from the number of sub-groups of another group. The number of sub-groups of one group may equal the number of sub-groups of another group. The number of participants of a sub-group may differ from the number of participants of another sub-group. The number of participants of a sub-group may equal the number of participants of another sub-group. The spatial relationships between the different groups and/or different sub-groups and/or different participants may differ from those illustrated in FIGS. 15 and 16.

Sound sources of members of a group may be represented by a single sound source that generates sound that reflects the sounds generated by the members of the group. Sound sources of members of a sub-group may be represented by a single sound source that generates sound that reflects the sounds generated by the members of the sub-group.

FIG. 15 illustrates an example of clustering of the sound sources into four groups.

First group G₀ 1510 includes first group centroid 1530 and four sub-groups SG_{0,0}-SG_{0,3} 1510-0, 1510-1, 1510-2 and 1510-3.

Second group G₁ 1511 includes second group centroid 1531 and four sub-groups SG_{1,0}-SG_{1,3} 1511-0, 1511-1, 1511-2 and 1511-3.

Third group G₂ 1512 includes third group centroid 1532 and four sub-groups SG_{2,0}-SG_{2,3} 1512-0, 1512-1, 1512-2 and 1512-3.

Fourth group G₃ 1513 includes fourth group centroid 1533 and four sub-groups SG_{3,0}-SG_{3,3} 1513-0, 1513-1, 1513-2 and 1513-3.

As indicated above, each group and sub-group is represented by a centroid, whose location is the center of gravity of the sources in the group or sub-group respectively. Additionally, the server accumulates all the sounds within the group or sub-group to one sound track.

The result is that the server has the following elements available:
a. Four group centroids, each with one accompanying soundtrack which is a compilation of all the sounds emanating from within the group.
b. 16 sub-group centroids, each with one accompanying soundtrack which is a compilation of all the sounds emanating from within the sub-group.
c. For each sound source—its location and accompanying soundtrack. In this document, each such element is represented by (l,s) where l represents the location of the element and s represents the soundtrack of the element.

To clarify, each one of the elements, whether it is a group, sub-group or sound source is represented by a pair {location, soundtrack}.

So, in the case of 64 sound sources, the server will hold 84 elements (4 Groupd+16Sub-Groups+64 sources).

Each participant creates a virtual space for one of the participants which will be one of the sound sources. There may be additional sound sources—such as speaker systems—but each participant is always one of the sound sources.

Let the participant represent a sound source whose element is represented by (L,S) be located in sub-group G_{m,n} where m,n={0 . . . 3} within group Gₘ.

The server sends the participant the following elements:
a. All the elements which share the same sub-group as the participant:

∀(l,s)∈SG_{m,n} and (l,s)≠(L,S)
b. All the other sub-groups which are in the same group as the participant (one element per sub-group):

∀(SG_{m,j}) where (j≠n)
c. All the other groups (one element for each group):

∀(Gᵢ) where (i≠m)

FIG. 16 shows an example of sound information of a participant P2 1542 of second sub-group SG_{2,0}. The second sub-group SG₂₁ also includes participants P0 1540, P1 1541 and P3 1543.

The sound information of participant P2 may include:
Elements that represents a sound source for each one of the members of the second sub-group SG_{2,1}—sound source 1540′ for P0 1540, sound source 1541′ for P1 1541, and sound source 1543′ for P3 1543.
Elements representing the sub-groups SG_{2,0}, SG_{2,2} and SG_{2,3}—such as sound source SG_{2,0} 1522-0, sound source SG_{2,2} 1522-2, and sound source SG_{2,3} 1522-3. Each sound source is represented by a pair of {location, soundtrack}
3 elements representing the groups G₀, G₁ and G₃—such as sound source G₀ 1520, sound source G₁ 1521, and sound source G₃ 1523. Each sound source is represented by a pair of {location, soundtrack}.

Suppose in our example, that there are 64 sound sources that all the groups and sub-groups are balanced (4 sound sources in each sub-group). In this case, the server will send 3 elements that share the same sub-group as the participant represented by the participant, 3 elements representing the other sub-groups in the same group and 3 elements for the other three groups: a total of 9 elements.

This guarantees the following:
a. The participant will be able to recreate accurately the sound sources co-located in the same sub-group as the participant represented by the participant.
b. The participant will be able to recreate with good accuracy all the other sound sources co-located in the same group the participant represented by the participant.
c. The participant will be able to recreate with reduced accuracy the sound sources located in the groups that differ from the group where the participant represented by the participant is located.

According to an embodiment, there is no need to generate balanced (equal sized) clusters.

According to an embodiment, balanced clusters may be provided.

Adding balancing may be performed, for example, in one of the forms described in:
a. Equal-Size spectral clustering, Carmen Adriana Martinez Barbosa, www.towardsdatascience.com, Feb. 6, 2023.
b. Clustering into same size clusters, Hippocamplus, http://jmonolog,github.io/Hippocamplus/2028/06/09, Jun. 9, 2018.
   Same-size k-Means Variation, https://elki-project.github.io/tutorial/same-size k means
   K-means algorithm variation with equal cluster size, Stack overflow, https://stackoverflow.com/questions/5452576/k-means-algorithm-variation-with-equal-cluster-size.

According to an embodiment, clustering may take into account not only the location of the sound sources but also their volume.

According to an embodiment, clustering and creating a soundtrack for groups and sub-groups may also take into account the direction of the sound as created by the sound sources.

Benefits of the Solution

Consider the case where there are 64 participants. If the participant for one participant needs to recreate the sounds of all the other participants, this means that it needs to receive 63 soundtracks and recreate 63 sources with their spatial effects. Such a solution is very bandwidth expensive and very resource demanding.

Suppose in our example we create balanced clusters. This means that each group has 16 participants, and each sub-group has 4 participants. In this case, the participant's participant will only need to recreate 3 sounds for the other groups, 3 sounds for the other sub-groups in the same group as the participant and the 3 other participants in the same sub-group. This is a total of 9 sources (3+3+3) instead of 63.

In fact the number of sources that would be recreated would always be six (3 groups and 3 sub-groups) plus the (number_of_participants/16)−1.

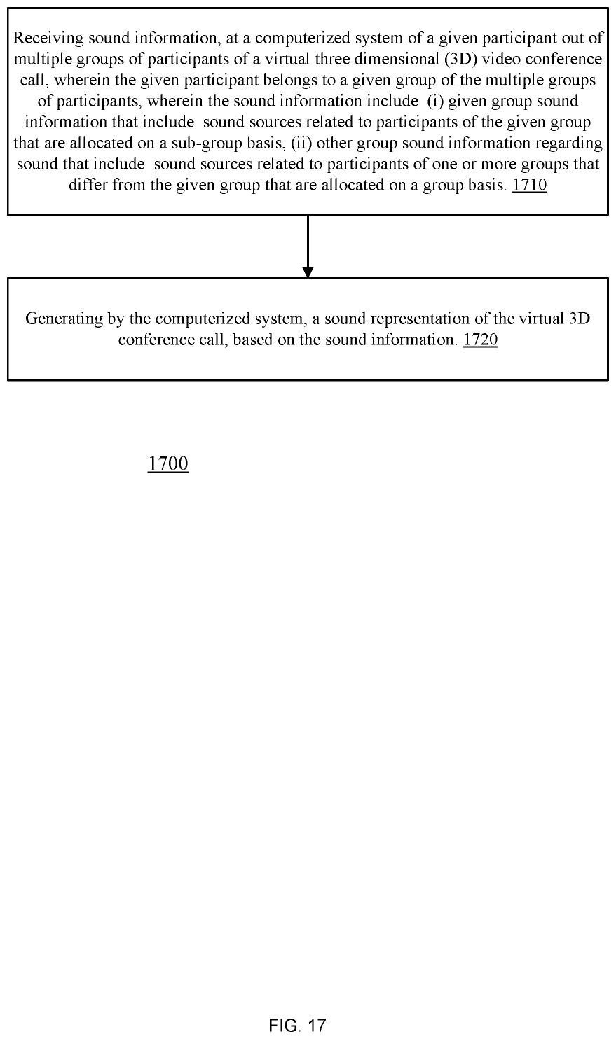

FIG. 17 illustrates an example of a method 1700.

According to an embodiment, method 1700 starts by step 1710 of receiving sound information, at a computerized system of a given participant out of multiple groups of participants of a virtual three dimensional (3D) video conference call, wherein the given participant belongs to a given group of the multiple groups of participants, wherein the sound information include (i) given group sound information that include sound sources related to participants of the given group that are allocated on a sub-group basis, (ii) other group sound information regarding sound that include sound sources related to participants of one or more groups that differ from the given group that are allocated on a group basis.

According to an embodiment, step 1710 is followed by step 1720 of generating by the computerized system, a sound representation of the virtual 3D conference call, based on the sound information.

According to an embodiment, the sound source related to a participant is a sound generated by the participant.

According to an embodiment, a sound source related to a participant is a sound generated by a computerized device of the participant.

According to an embodiment, participants of the multiple groups of participants are grouped based on spatial relationships between the participants. See, for example FIGS. 15 and 16.

According to an embodiment, participants of the multiple groups of participants are grouped based on distances between the participants and/or based on the angular relationship between the participants.

According to an embodiment, the given participant belongs to a given sub-group of the given group, wherein the sound information further include (iii) given sub-group information that include sound sources related to participants of the given sub-group that are allocated on a sub-sub-group basis.

According to an embodiment, the allocation on a sub-sub-group basis include allocating a sound source per participant of the given sub-group.

According to an embodiment, the multiple groups of participants are four groups of participants, and there up to four sub-groups per each group of the multiple groups of participants.

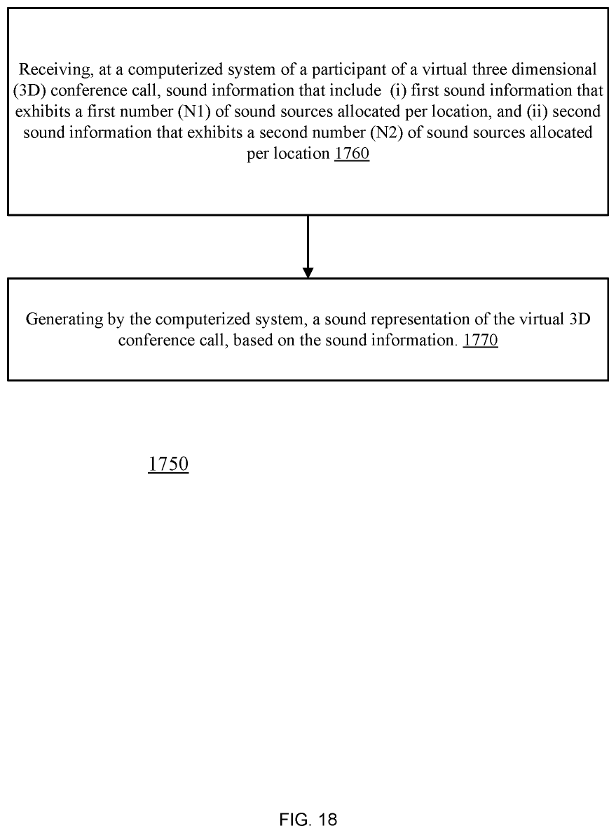

FIG. 18 illustrates an example of method 1750.

According to an embodiment, method 1750 starts by step 1760 of receiving, at a computerized system of a participant of a virtual three dimensional (3D) conference call, sound information that include (i) first sound information that exhibits a first number (N1) of sound sources allocated per location, and (ii) second sound information that exhibits a second number (N2) of sound sources allocated per location.

According to an embodiment, step 1760 is followed by step 1770 of generating by the computerized system, a sound representation of the virtual 3D conference call, based on the sound information.

According to an embodiment, N2 differs from N1.

According to an embodiment, N1 equals one and N2 exceeds one.

According to an embodiment, the first sound information represents first sound sources, wherein the second sound information represents second sound sources.

According to an embodiment, N1 is smaller than N2 and the first sound sources are more associated to the participant than the second sound sources.

According to an embodiment, the first sound sources are closer to the participant in relation to the second sound sources.

According to an embodiment, the first sound sources belong to a same sub-group of sound sources as the participant, wherein the second sound sources do not belong to the same sub-group of sound sources as the participant.

According to an embodiment, the sub-group of sound resources are generated by clustering of sound sources based on location.

According to an embodiment, the sound information include third sound information that exhibits third number (N3) of sound sources allocated per location, wherein the third sound information represent third sound sources, wherein N3 differs from N1 and differs from N2.

According to an embodiment, wherein N1 is smaller than N2 and N2 is smaller than N3.

According to an embodiment there is provided a method for generating the sound information of step 1710.

According to an embodiment there is provided a method for generating the sound information of step 1760.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

The connections as discussed herein may be any type of connection suitable to transfer signals from or to the respective nodes, units, or devices, for example via intermediate devices. Accordingly, unless implied or stated otherwise, the connections may for example be direct connections or indirect connections. The connections may be illustrated or described in reference to be a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments of the disclosures containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the embodiments of the disclosure.

1. A method, comprising:
receiving sound information, at a computerized system of a given participant out of multiple groups of participants of a virtual three dimensional (3D) conference call, wherein the given participant belongs to a given group of the multiple groups of participants, wherein the sound information comprises (i) given group sound information that comprises sound sources related to participants of the given group that are allocated on a sub-group basis, (ii) other group sound information regarding sound that comprises sound sources related to participants of one or more groups that differ from the given group that are allocated on a group basis; and
generating by the computerized system, a sound representation of the virtual 3D conference call, based on the sound information.

2. The method according to claim 1, wherein a sound source related to a participant is a sound generated by the participant.

3. The method according to claim 1, wherein a sound source related to a participant is a sound generated by a computerized device of the participant.

4. The method according to claim 1, wherein participants of the multiple groups of participants are grouped based on spatial relationships between the participants.

5. The method according to claim 1, wherein participants of the multiple groups of participants are grouped based on distances between the participants.

6. The method according to claim 1, wherein the given participant belongs to a given sub-group of the given group, wherein the sound information further comprises (iii) given sub-group information that comprises sound sources related to participants of the given sub-group that are allocated on a sub-sub-group basis.

7. The method according to claim 6, wherein the allocation on a sub-sub-group basis comprises allocating a sound source per participant of the given sub-group.

8. The method according to claim 1 wherein the multiple groups of participants are four groups of participants, and there up to four sub-groups per each group of the multiple groups of participants.

9. A non-transitory computer readable medium that stores instructions for:
receiving sound information, at a computerized system of a given participant out of multiple groups of participants of a virtual three dimensional (3D) conference call, wherein the given participant belongs to a given group of the multiple groups of participants, wherein the sound information comprises (i) given group sound information that comprises sound sources related to participants of the given group that are allocated on a sub-group basis, (ii) other group sound information regarding sound that comprises sound sources related to participants of one or more groups that differ from the given group that are allocated on a group basis; and
generating by the computerized system, a sound representation of the virtual 3D conference call, based on the sound information.

10. The non-transitory computer readable medium according to claim 1, wherein the given participant belongs to a given sub-group of the given group, wherein the sound information further comprises (iii) given sub-group information that comprises sound sources related to participants of the given sub-group that are allocated on a sub-sub-group basis.

11. A method, comprising:
receiving, at a computerized system of a participant of a virtual three dimensional (3D) conference call, sound information that comprises (i) first sound information that exhibits a first number (N1) of sound sources allocated per location, and (ii) second sound information that exhibits a second number (N2) of sound sources allocated per location; and
generating by the computerized system, a sound representation of the virtual 3D conference call, based on the sound information.

12. The method according to claim 11, wherein N2 differs from N1.

13. The method according to claim 12, wherein N1 equals one and N2 exceeds one.

14. The method according to claim 12, wherein the first sound information represent first sound sources, wherein the second sound information represents second sound sources.

15. The method according to claim 12, wherein N1 is smaller than N2 and wherein the first sound sources are more associated to the participant than the second sound sources.

16. The method according to claim 11, wherein the first sound sources are closer to the participant in relation to the second sound sources.

17. The method according to claim 11, wherein the first sound sources belong to a same sub-group of sound sources as the participant, wherein the second sound sources do not belong to the same sub-group of sound sources as the participant.

18. The method according to claim 17, wherein the sub-group of sound resources are generated by clustering of sound sources based on location.

19. The method according to claim 11, wherein the sound information comprises third sound information that exhibits third number (N3) of sound sources allocated per location, wherein the third sound information represent third sound sources, wherein N3 differs from N1 and differs from N2.

20. The method according to claim 19, wherein N1 is smaller than N2 and N2 is smaller than N3.

21. A non-transitory computer readable medium that stores instructions for:
receiving, at a computerized system of a participant of a virtual three dimensional (3D) conference call, sound information that comprises (i) first sound information that exhibits a first number (N1) of sound sources allocated per location, and (ii) second sound information that exhibits a second number (N2) of sound sources allocated per location; and
generating by the computerized system, a sound representation of the virtual 3D conference call, based on the sound information.
